(19) United States
(12) Patent Application Publication
(10) Pub. No.: US 2006/0252409 A1
(43) Pub. Date: Nov. 9, 2006

(54) Electronic capture, storage and transmission of client data at point-of-sale

(76) Inventors: Robert K. Brenchley, Kaysville, UT (US); Travis S. Romney, Woods Cross, UT (US)

Correspondence Address: MORRISS O'BRYANT COMPAGNI, P.C., 136 SOUTH MAIN STREET, SUITE 700, SALT LAKE CITY, UT, 84101, US

(21) Appl. No.: 11/417,710

(22) Filed: May 4, 2006

Related U.S. Application Data
(60) Provisional application No. 60/677,850, filed on May 4, 2005.

(51) Int. Cl. H04M 11/00; H04Q 7/38

(52) U.S. Cl. 455/405; 455/406; 455/414.1

(57) ABSTRACT

An embodiment of a method for activating rate plans for mobile phone customers at a point-of-sale is disclosed. The method may include placing customer information into a central database and selecting a rate plan associated with a selected carrier. The method may further include accessing an activation system for the selected carrier and pushing customer information from the central database into the activation system. The method may further include generating a customer rate plan contract, obtaining an executed contract and sending the executed contract to at least one of: the customer, the carrier and the central database. A system for implementing the method is also disclosed. Computer media for storing computer-readable instructions implementing the method are also disclosed.

### CROSS-REFERENCE TO RELATED APPLICATIONS

This nonprovisional patent application claims benefit and priority under 35 U.S.C. § 119(e) of the filing of U.S. Provisional Patent Application Ser. No. 60/677,850 filed on May 4, 2005, titled “ELECTRONIC CAPTURE, STORAGE AND TRANSMISSION OF CLIENT DATA AT POINT-OF-SALE,” the contents of which are expressly incorporated herein by reference for all purposes.

### BACKGROUND OF THE INVENTION

1. Field of the Invention

This invention relates generally to methods and systems for manipulating client data electronically. More particularly, the invention relates to electronic capture, storage and transmission of client data at point-of-sale.

2. Description of Related Art

Currently a consumer enters a cellular retail store to obtain cellular service by activating a rate plan and possibly purchasing a cellular phone. In order to activate a rate plan for the customer, the cellular retailer logs into the carrier activation website and enters the customer's information, including name, address and social security number. The customer's credit is checked based on the customer's information. If the customer is not credit worthy, a deposit may be required. A rate plan may then be selected and a mobile phone number assigned to the customer's cellular phone.

The mobile phone number may be assigned via a unique electronic serial number (ESN) tied to the phone for U.S. telephone networks. The International Mobile Equipment Identity (IMEI) number is a unique number given to every single mobile phone connected to a Global System for Mobile Communication (GSM) network used in European countries. The IMEI numbers are stored in a database, known as the Equipment Identity Register (EIR), which contains all valid mobile phone handsets. When a phone is reported stolen or is otherwise not approved, the number is marked invalid in the EIR and calls will not be allowed on the GSM network. The ESN and IMEI codes are distinct from each other and are both associated with GSM phones.

The IMEI number may be stored in a unique subscriber identification module (SIM), inserted into a phone compatible with European mobile phone networks, i.e., those networks that follow the GSM standard. A SIM is a smart card inside of a GSM cellular phone that encrypts voice and data transmissions and stores data about the specific user, so that the user can be identified and authenticated to the network supplying the phone service. The SIM may also store data such as personal numbers and phone settings specific to the user. A SIM can be moved from one phone to another and/or different SIMs can be inserted into any GSM phone. For example, if a user has one phone but uses it for both personal and business calls, he can change the SIM depending on how he will be using the phone (one SIM card contains his personal identity and data and the second SIM card carries his business identity and data).

The carrier's website then produces a contract in the form of a hyper-text markup language (HTML) document or portable document format (.pdf). The contract is printed by the cellular retailer and signed by the customer. A printed copy of the signed contract is given to the customer. A printed copy of the signed contract is kept in storage by the cellular retailer for reconciliation purposes. Finally, a printed copy of the signed contract is sent back to the carrier. The phone is then ready for programming for use on the carrier's network.

The cellular retailer earns commissions based, at least in part, on the number of rate plan activations that occur in a given period of time. Typically, a monthly report is either emailed to the carrier, or downloaded from the cellular retailer by the carrier. The monthly report will list all of the activations that occurred during the previous month. For every rate plan activated, the carrier pays a commission to the cellular retailer. The monthly report is compared against the cellular retailer's records (printed contracts, invoices, etc.) to verify that the commissions are getting paid correctly, i.e., reconciliation.

One known problem with the conventional method of activating mobile phone customers at a cellular retailer is the duplication of customer information data entry: first into the carrier's database and a second into the cellular retailer's client database. U.S. Published Patent Application No. 2006/0009218 to Moss discloses one approach to solving the double data entry problem. Moss discloses an Internet-based cellular telephone service accounting method and system for registering wireless telephone users. The Moss system allows the cellular retailer to select a carrier and rate plan, enter customer information, determine credit worthiness or the need for a deposit, enter an ESN and phone number, print a service agreement and extract the duplicative information from the carrier's database for placement in the cellular retailer's database, thus avoiding the duplication of the data entry.

However, there are other problems associated with the conventional method of activating mobile phone customers at a cellular retailer's point-of-sale. Such problems include the time required to perform the reconciliation process, calculating commissions and apportioning them among sales people. Another problem is calculating profit and loss based on cancellations and deactivations. Yet another problem is tracking phone and accessory inventory. Another problem with conventional systems is that the customer service agreement must be printed and hand-signed by the cellular subscriber (customer) and hard copies retained by both the cellular retailer and the cellular carrier.

Thus, it would be highly advantageous to provide electronic capture, storage and transmission of client data at point-of-sale which would be capable of solving the aforementioned problems.

### SUMMARY OF THE INVENTION

An embodiment of a method for activating rate plans for mobile phone customers at a point-of-sale is disclosed. The method may include placing customer information into a central database and selecting a rate plan associated with a selected carrier. The method may further include accessing an activation system for the selected carrier and pushing customer information from the central database into the activation system. The method may further include generating a customer rate plan contract, obtaining an executed contract and electronically sending the executed contract to a customer, the carrier and the central database.

An embodiment of a system for activating rate plans for mobile phone customers at point-of-sale is also disclosed. The system may include a computer configured for Internet access and a central database for storing customer information. The system may include a web browser configured for executing computer-executable instructions for implementing a method for activating rate plans for mobile phone customers at a point-of-sale. The method may be as described above.

Additional features and advantages of the invention are set forth in the detailed description with reference to the drawings, below.

### BRIEF DESCRIPTION OF THE DRAWINGS

The following drawings illustrate exemplary embodiments for carrying out the invention. Like reference numerals refer to like parts in different views or embodiments of the present invention in the drawings.

FIG. 1 is a flow chart of an embodiment of a method for activating mobile phone customers at a point-of-sale according to the present invention.

FIG. 2 is a block diagram of a computer-readable medium having computer-executable instructions for performing the method of FIG. 1.

FIG. 3 is a block diagram of a system for activating rate plans for mobile phone customers at a point-of-sale according to an embodiment of the present invention.

FIG. 4 is a block diagram of another embodiment of a system for activating rate plans for mobile phone customers from multiple cellular retailers according to the present invention.

FIG. 5 is an exemplary screen capture of an activation link screen according to the present invention.

FIG. 6 is an exemplary screen capture of downloading and launching a web browser, according to the present invention.

FIG. 7 is an exemplary screen capture of a carrier activation website login page, according to the present invention.

FIG. 8 is an exemplary screen capture of a carrier activation credit check page, according to the present invention.

FIG. 9 is an exemplary screen capture of a carrier rate plan selection page, according to the present invention.

FIG. 10 is an exemplary screen capture of a billing information page, according to the present invention.

FIG. 11 is an exemplary screen capture of a handset identifier code data entry page, according to the present invention.

FIG. 12 is an exemplary screen capture of a rate plan contract creation page, according to the present invention.

FIG. 13 is an exemplary screen capture of an activation complete page, according to the present invention.

FIG. 14 is an exemplary screen capture of a dialog box for electronically storing the executed contract, according to the present invention.

### DETAILED DESCRIPTION OF THE INVENTION

The invention is a method and system for facilitating mobile phone activations by cellular retailers, i.e., a point-of-sale. Embodiments of the present invention may also be used to: (1) manage inventory of cellular handsets and accessories, (2) manage cellular retailer employees based on sales performance, (3) track and reconcile retailer and employee sales commissions, (4) share sales information between multiple stores in a single retail chain, (5) perform cash drawer management, (6) manage transfers and (7) manage customer information. While the various embodiments of the present invention will be described in the context of retail sales and activation of cellular phones, the concepts may be applied to other point-of-sale transactions by extension of the concepts disclosed herein.

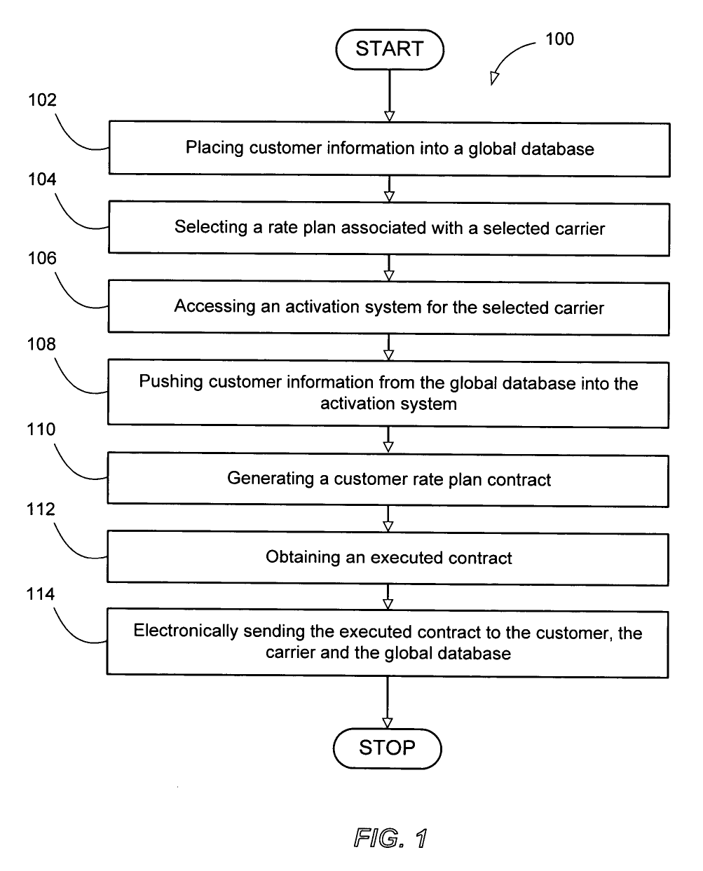

FIG. 1 is a flow chart of an embodiment of a method 100 for activating rate plans for mobile phone customers at a point-of-sale according to the present invention. Method 100 may include placing 102 customer information into a central database. Method 100 may further include selecting 104 a rate plan associated with a selected carrier. Method 100 may include accessing 106 an activation system for the selected carrier. Method 100 may include pushing 108 customer information from the central database into the activation system. Method 100 may include generating 110 a customer rate plan contract. Method 100 may include obtaining 112 an executed contract and sending 114 the executed contract to the customer and/or the carrier and/or the central database.

Placing 102 customer information into a central database may include entering any sort of relevant customer information, including but not limited to: name, address, telephone number, mobile phone number, social security number, driver license number, credit card number, billing address, business name, email address and purchase history, according to one embodiment of the present invention. This customer information may be used to perform a credit check on the customer and also for billing and contact information. Purchase history information may be stored automatically at the close of each customer transaction, according to one embodiment of the present invention. Alternatively, purchase history information may be entered manually by the retail sales representative according to another embodiment of the present invention.

Cellular retailers may desire to rename carrier's rate plans for their own marketing or other purposes. The method 100 of the present invention allows the mapping of a cellular retailer's rate plan to an actual carrier rate plan. This feature streamlines the rate plan selection process from the cellular retailer to the cellular customer. Selecting 104 a rate plan associated with a selected carrier may include selecting a retailer rate plan mapped to a carrier rate plan, according to one embodiment of the present invention.

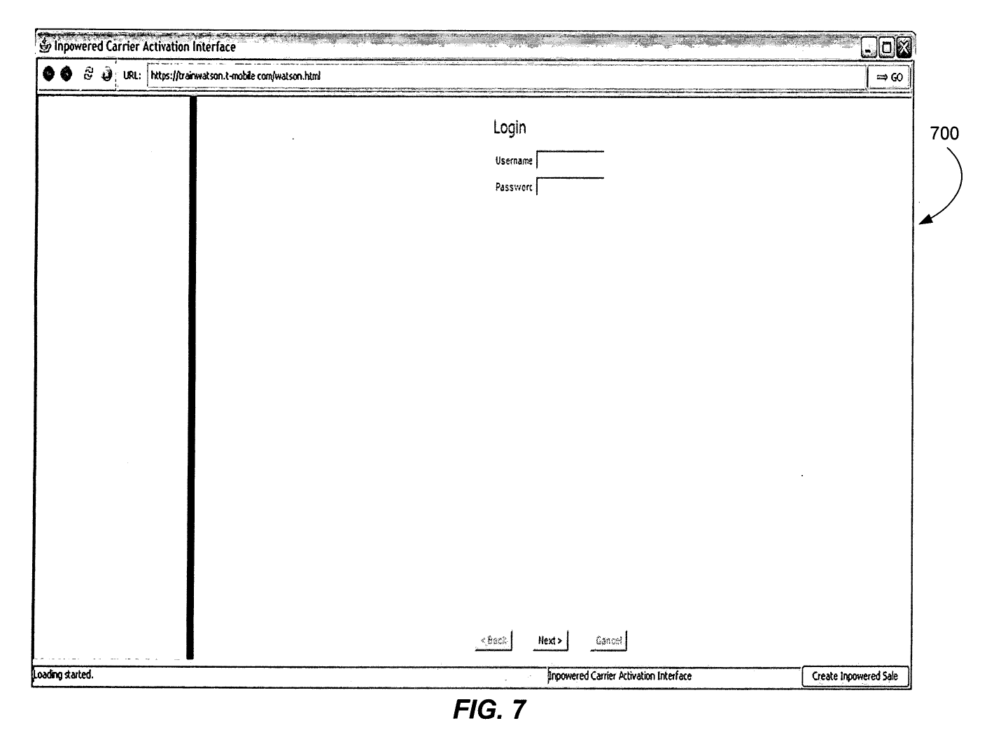

Accessing 106 an activation system for the selected carrier may include logging into the activation system with a cellular retailer's unique login identification (ID) and password. See for example FIG. 7 and related discussion below. The cellular retailer's ID and password are established by the relationship between the retailer and the carrier for whom activations are being sought.

According to one embodiment of method 100, pushing 108 customer information into the selected carrier activation system may include an application program interface (API) for retrieving customer information from the central database and inserting it into forms on web pages in the selected carrier activation system. Of course, those skilled in the art will recognize that other equivalent methods may be employed to automatically move customer data from the central database into the selected carrier activation system. Such alternative methods are contemplated to be within the scope of the present invention.

According to an embodiment of method 100, generating 110 a customer rate plan contract may include copying a contract generated by the selected carrier activation system.

According to an embodiment of method 100, obtaining 112 an executed contract may include the cellular customer signing a printed copy of the customer rate plan contract. According to another embodiment of method 100, obtaining 112 an executed contract may include digitally capturing a customer signature and inserting it into the customer rate plan contract. The digital capture of the customer signature may be facilitated by a digital signature pad. For example and not by way of limitation, various liquid crystal display (LCD) digital signature pads and related application software are available from Topaz Systems, Inc., topazsystems.com.

According to an embodiment of method 100, obtaining 112 an executed contract may include generating an Adobe Systems, Inc. Acrobat™ formatted rate plan contract with a customer signature, in portable document format (PDF, or file extension, .pdf). PDF is a file format created by Adobe Systems, Inc. PDF formatted documents use the PostScript printer description language and are highly portable across computer platforms. PDF versions of documents are particularly useful for storing and transmitting documents electronically, as they are readily viewable and printable from within Adobe Systems, Inc., Acrobat Reader™ application software, which is freely available.

According to an embodiment of method 100, sending 114 the executed contract to the cellular customer and/or the carrier may be achieved by emailing the executed contract. According to another embodiment of method 100, sending 114 the executed contract to the central database may be accomplished by copying the executed contract into the central database.

The customer information stored in the central database may be for other purposes according to the present invention. According to one embodiment, method 100 may further include pushing customer and equipment information from the central database directly into a third party warranty database (not shown in FIG. 1).

In the context of multiple stores using the method and system of the present invention, it may be particularly useful for each store to have access to real-time information regarding sales (rate plan activations and equipment sales) at each store to generate inter-store competition for sales. According to one embodiment, method 100 may further include displaying current sales totals on a store-by-store basis. Displaying current sales totals may be displayed in the format of a moving ticker display in a portion of a computer display window according to one embodiment of the present invention. One of ordinary skill in the art will recognize that other display formats may be used to display current sales data in real-time, for example and not by way of limitation, tables, periodic emails and reports. Any suitable means of displaying real-time sales data on a store-by-store basis is contemplated to be within the scope of the present invention.

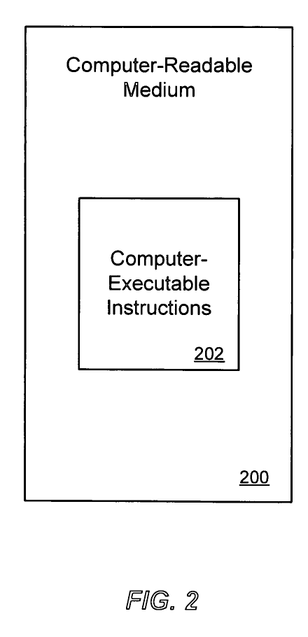

FIG. 2 is a block diagram of a computer-readable medium 200 having computer-executable instructions 202 for performing method 100. The computer-readable medium may be any portable media for storing computer-executable instructions, including but not limited to: compact disc read-only-memory (CD-ROM), CD recordable (CD-R) media, CD rewriteable (CD-RW) media, magneto-optical (MO) media, digital versatile disc (DVD), DVD-rewriteable (DVD-RW) media and any other computer media for storing computer programs according to embodiments of the present invention. Alternatively, the computer-readable medium may be any solid state memory media for storing computer-executable instructions, including but not limited to: ROM, programmable ROM (PROM), eraseable programmable ROM (EPROM), electrically eraseable PROM (EEPROM) and flash memory according to embodiments of the present invention.

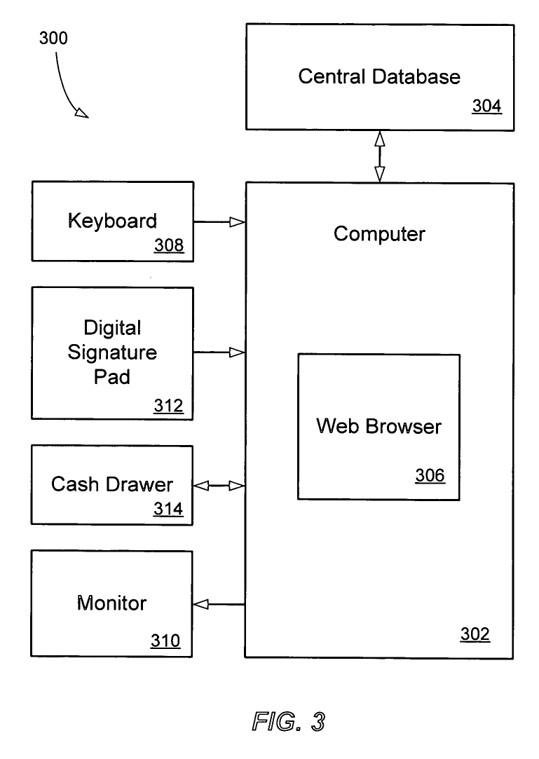

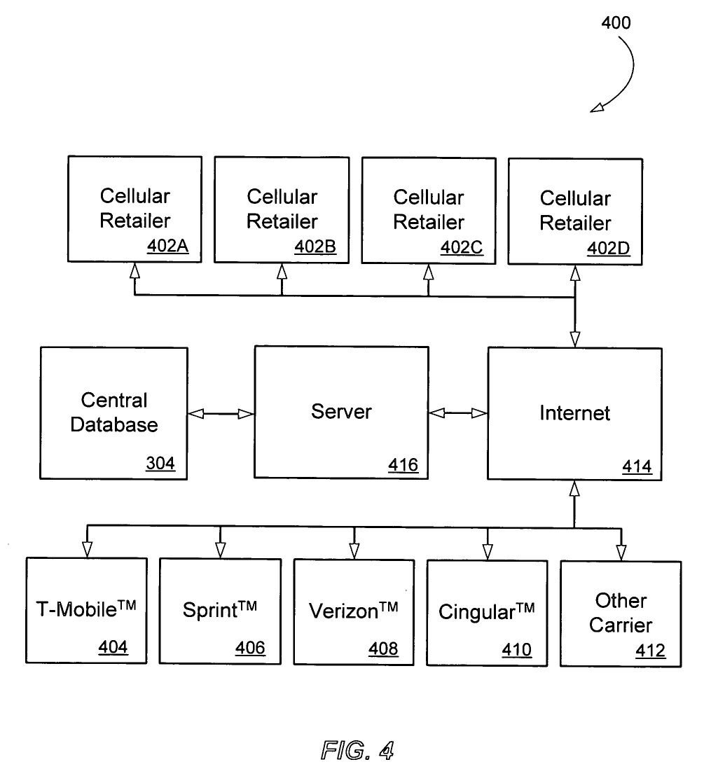

FIG. 3 is a block diagram of a system 300 for activating mobile phone customers at a POS, according to an embodiment of the present invention. System 300 may include a computer 302 configured for Internet access and a central database 304 for storing customer information. System 300 may further include a web browser 306 configured for executing computer-executable instructions 202 (see FIG. 2) in the computer 302 for implementing a method 100. System 300 may include a keyboard 308 in communication with the computer 302 for inputting customer information into the central database 304. System 300 may further include a monitor 310 for displaying the embedded web browser and various screens for implementing method 100, see for example FIGS. 4-13 and related discussion below. System 300 may further include a digital signature tablet or pad 312 in communication with the computer 302 for capturing customer signatures in the customer rate plan contract to obtain the executed contract. System 300 may further include a cash drawer 314 in communication with the computer. The cash drawer 314 may be configured for storage and distribution of currency and other monetary instruments. Note that system 300 may run any suitable operating system, for example but not by way of limitation: Windows™, Linux™, Unix™, Solaris™ and Mac OS™, on any suitable microprocessor architecture.

FIG. 4 is a block diagram of another embodiment of a system 400 for activating mobile phone customers from multiple cellular retailers 402A-D according to the present invention. System 400 may include a plurality of cellular retailers 402A-D (four shown in FIG. 4) with access to the public Internet 414. System 400 may further include a plurality of cellular phone service carriers also having activation websites accessible through the public Internet 414. For example, T-Mobile™ 404, Sprint™ 406, Verizon™ 408, Cingular™ 410 and any other cellular service carrier 412 may host a cellular service activation website that is accessible by each of the cellular retailers 402A-D according to agreements arranged between the cellular retailers 402A-D and the carriers 404-412 using unique login identifications and passwords. System 400 may further include a server 416 providing access to the central database 304 through embedded web browsers at the cellular retailers 402A-D.

The systems 300 and 400 shown in FIGS. 3-4 are merely exemplary and, those skilled in the art will readily recognize topographical or structural changes to the block diagram of system 400 to accomplish the same function of the present invention. For example, the central database 304 shown in FIG. 4 may be distributed, i.e., local instances at each of the cellular retailers 402A-D, or centralized as shown in FIG. 4. Central database 304 may be physically present on the server 416 rather than distinct as shown in FIG. 4. All of these alternative configurations are considered to be within the spirit and scope of the present invention.

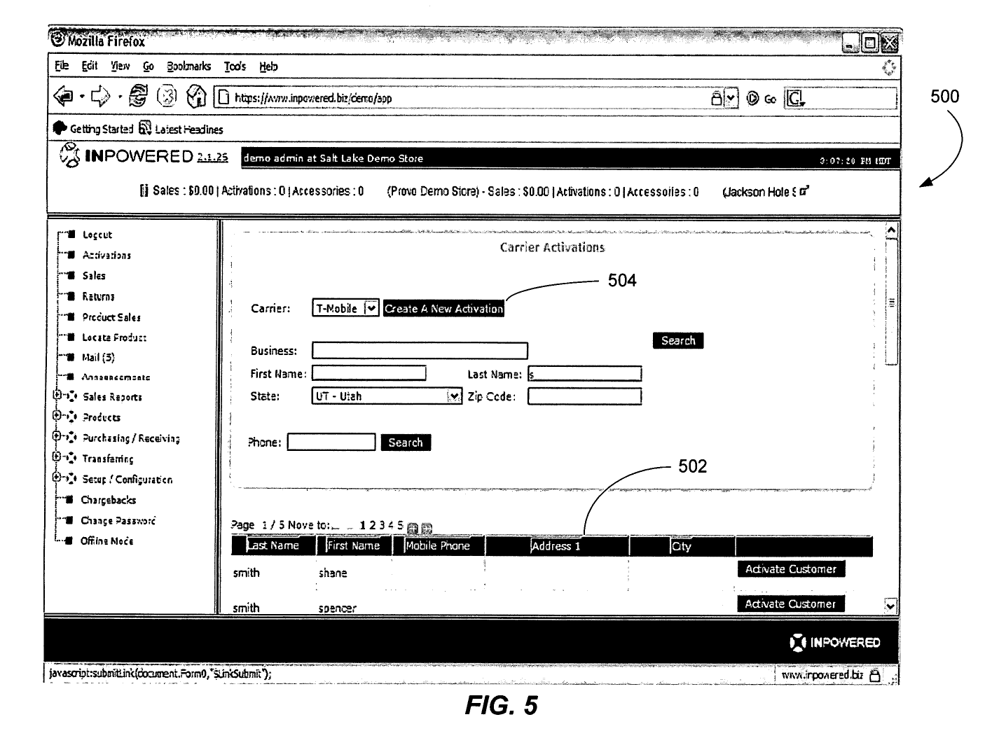

Method 100 may be implemented as a computer program or software application such as the embedded web browser 306 shown in FIG. 3. FIGS. 5-14 are representative screen shots generated by a particular software embodiment, e.g., computer-executable instructions (202, FIG. 2) in the form of a web browser (306, FIG. 3) for implementing method 100. FIGS. 5-14 and the related discussion below will explain in greater detail a particular embodiment of method 100, for activating a cellular customer.

Referring now to FIG. 5, an exemplary screen capture of an activation link screen 500 is shown, consistent with the present invention. Using the activation link screen 500, the user, e.g., a cellular retailer, may search to see if the cellular customer is a repeat customer, i.e., where the customer's information has already been entered into the central database (304, FIGS. 3-4), perhaps from a previous cellular activation. The activation link screen 500 allows a user to search a database of existing customers 502, by name or phone number. The database of existing customers 502 is specific to the cellular retailer and may be a subset of the central database (304, FIGS. 3-4). The activation link screen 500 further allows a user to select a carrier and initiate activation of the customer using the graphical user interface of a web browser (306, FIG. 3), by clicking the “Create A New Activation” button 504. The embedded web browser (306, FIG. 3) automatically logs into the selected carrier's activation website with the correct uniform resource locator (URL) or web address along with the unique cellular retailer identification (ID) and password.

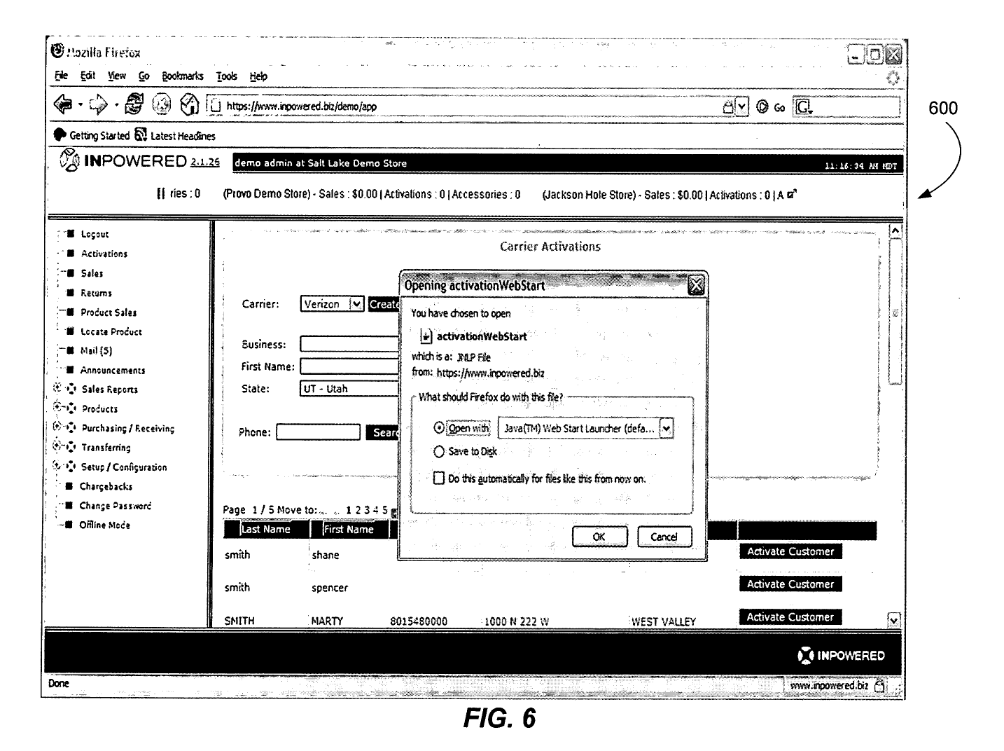

Referring now to FIG. 6, an exemplary screen capture of downloading and launching a web browser is shown, according to the present invention. By clicking the “Create A New Activation” button (504, FIG. 5), Java Web Start™ downloads and launches the JDesktop Integration Components™ (JDIC) web browser. Java Web Start™ and the JDIC™ web browser are available from Sun Microsystems, Inc., Santa Clara, Calif. While the use of Sun Microsystems web browser technology is illustrated in FIG. 6, the invention is not limited to Sun's web browser technology. Any suitable web browser or embedded web browser may be used consistent with the principles of the invention disclosed herein.

Referring now to FIG. 7, an exemplary screen capture of a carrier activation website login page 700 is shown according to the present invention. The particular carrier activation website login page 700 illustrated in FIG. 7 is for cellular carrier, TMobile™, just prior to the login ID and password being transferred from the central database to the carrier activation website. Applicant's embedded web browser automatically logs into the carrier's activation website. The features and layout of various carrier's activation website pages shown in FIG. 7 and elsewhere may be owned by the various carrier's or other third parties under copyright and other laws. Applicant makes no claim whatsoever to such features and layouts pertaining to carrier or third party websites.

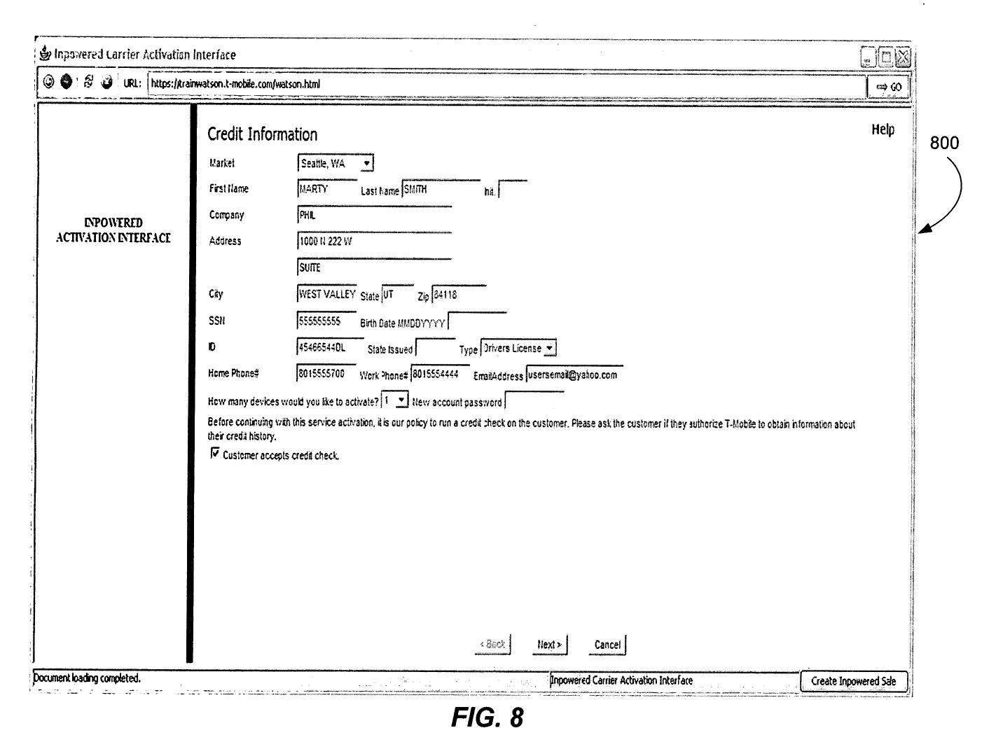

Referring now to FIG. 8, an exemplary screen capture of a carrier activation credit check page 800 is shown, according to the present invention. FIG. 8 shows the customer information automatically and securely transferred (108, FIG. 1) from the central database (304, FIGS. 3-4) into the form shown on carrier activation credit check page 800. Any additional information required by the carrier to perform the credit check, including customer acceptance of the credit check may be entered by the cellular retailer sales representative at the carrier activation credit check page 800. Any updated information on the carrier activation credit check page 800 may be transferred into the retailer's customer information database and the central database (304, FIGS. 3-4). Clicking the “Next” button will perform the credit check function at the carrier activation website.

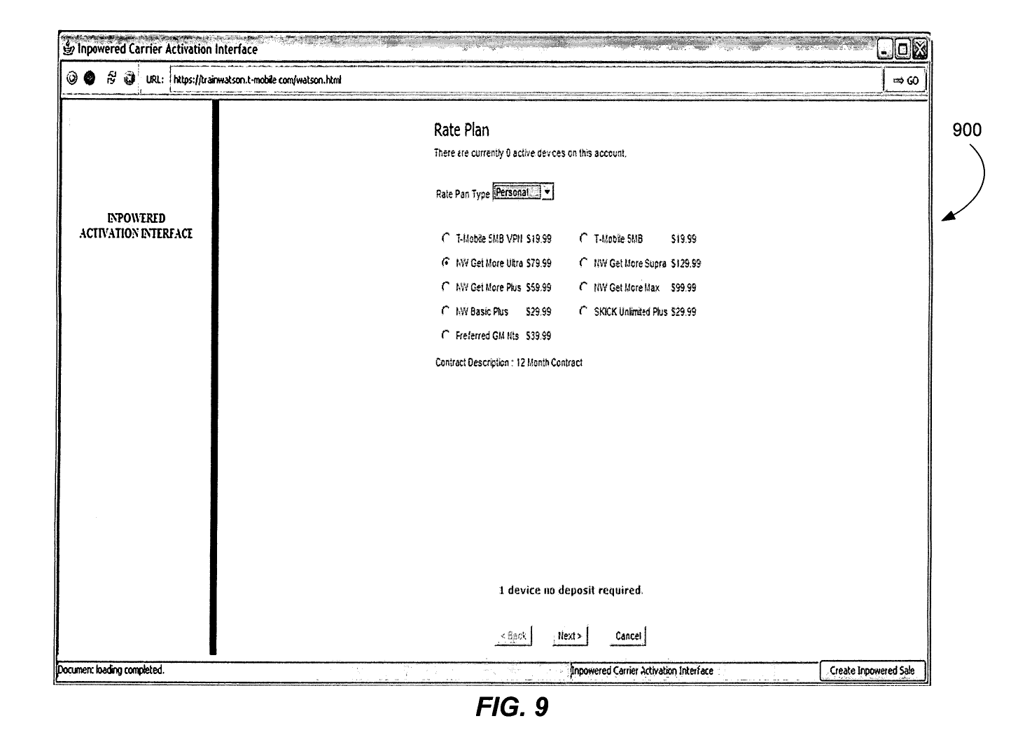

FIG. 9 is an exemplary screen capture of a carrier rate plan selection page 900, according to the present invention. Assuming the customer's credit check passed, the carrier rate plan selection page 900 allows the cellular retailer sales representative or user to select the customer's desired rate plan by clicking on a radio button next to the selected rate plan. The carrier rate plan selection page 900 may indicate whether a deposit is required based on the customer's credit rating.

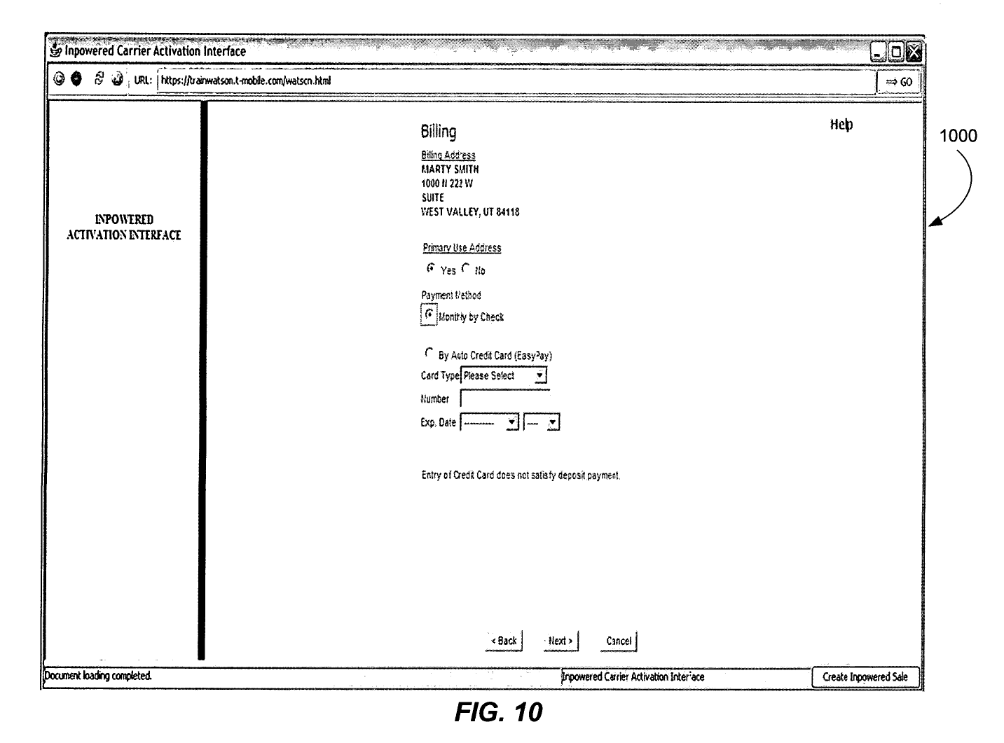

FIG. 10 is an exemplary screen capture of a billing information page 1000, according to the present invention. The billing information page 1000 allows the user to select the billing payment method for the monthly fee charged by the carrier. The payment method may be any suitable method, for example and not by way of limitation: monthly by check (first option shown in FIG. 10), automatic credit card payments (second option shown in FIG. 10) and automatic electronic funds transfers (not shown in FIG. 10).

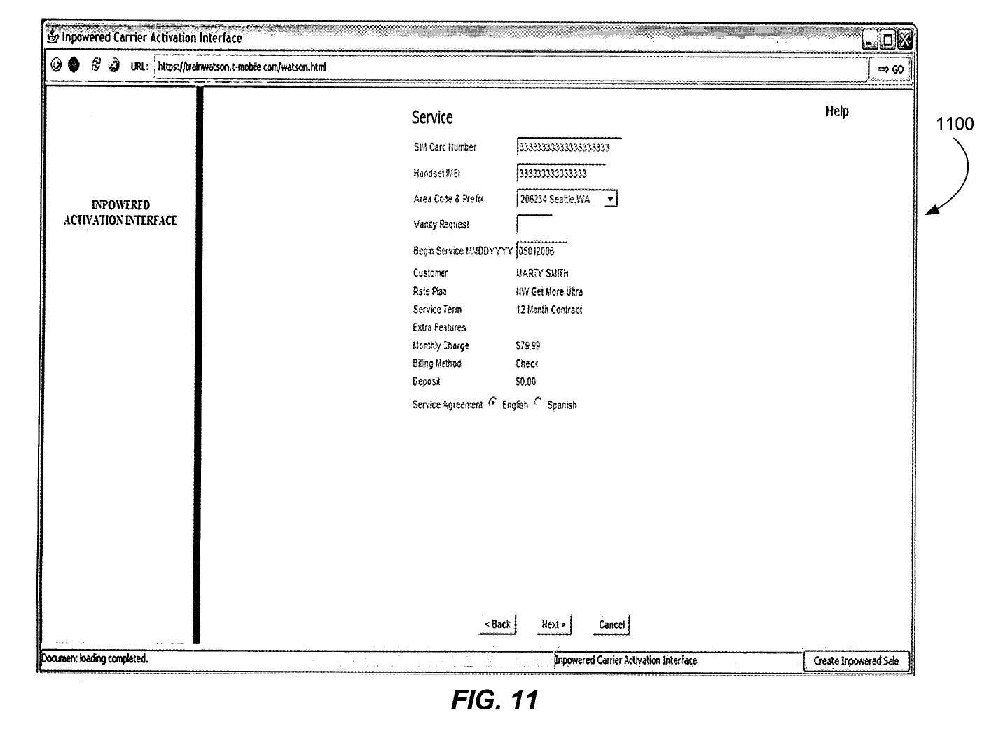

FIG. 11 is an exemplary screen capture of a handset identifier code data entry page 1100, according to the present invention. The handset identifier code data entry page 1100 allows the user to enter the ESN, IMEI, or SIM code information necessary for the particular phone to be used by the customer for the phone activation over the selected phone network. The ESN, IMEI, or SIM code information is associated with the selected rate plan and customer so that the carrier knows how to bill for air time based on calls. For cellular retailers who are activating a new phone from inventory, the ESN, IMEI, or SIM code information may be pre-entered into the cellular retailer's database and/or the central database (304, FIGS. 3-4). The handset identifier code data entry page 1100 also allows the user to enter a service begin date and to select whether the rate plan contract should be printed in English or Spanish.

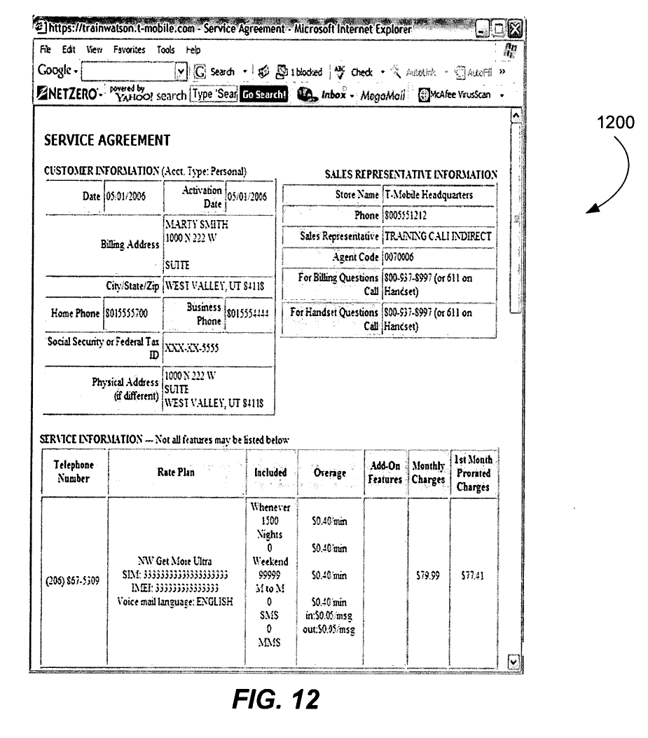

FIG. 12 is an exemplary screen capture of a rate plan contract creation page 1200, according to the present invention. The rate plan contract creation page 1200 shown in FIG. 12 shows the rate plan contract based on the previous page selections as generated by the carrier activation website. Conventionally, the user would have to print the rate plan contract and have the customer sign the hard copy of the contract to obtain an executed contract. Distinctive features of the present invention include the capability of electronically storing the rate plan contract, digitally capturing the customer's signature on the contract to obtain an executed contract and being able to store the executed contract in the central database (304, FIGS. 3-4).

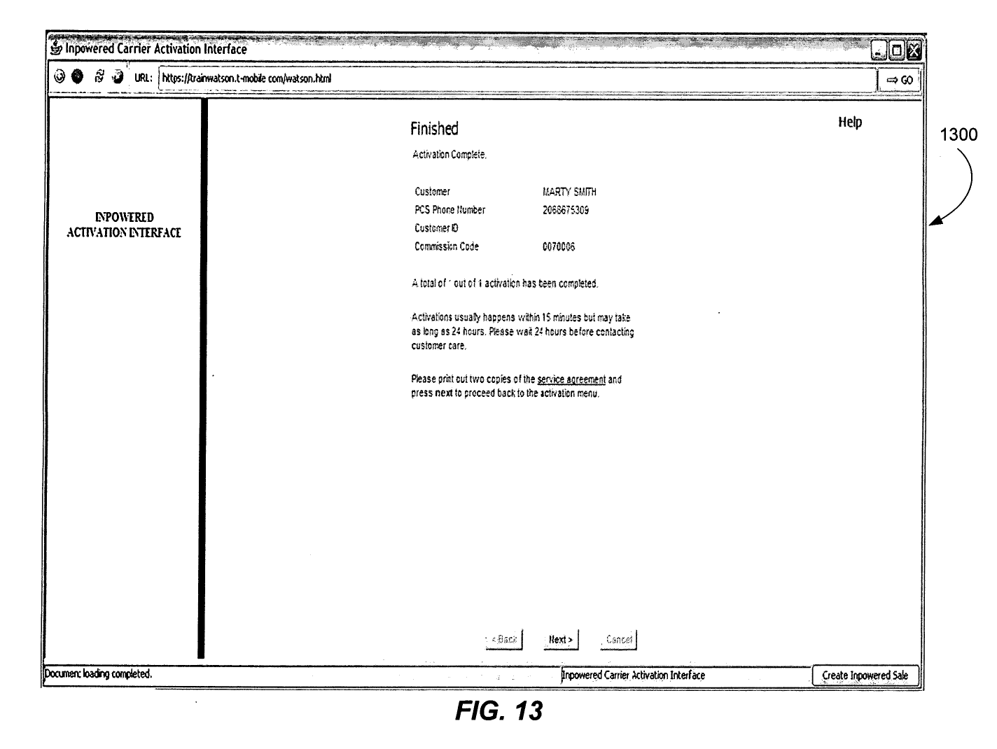

FIG. 13 is an exemplary screen capture of an activation complete page 1300, according to the present invention. The activation complete page 1300 shown in FIG. 13 may show a summary of the completed activation including customer name, phone number, customer ID, commission code and any other pertinent information relating to the completed activation. The activation complete page 1300 may also allow the user to print copies of the rate plan contract (sometimes referred to as a “service agreement”). Distinctive features of the present invention at this point in the process include the capability of automatically storing the new data from the activation into the central database (304, FIGS. 3-4) and/or the retailer's customer database.

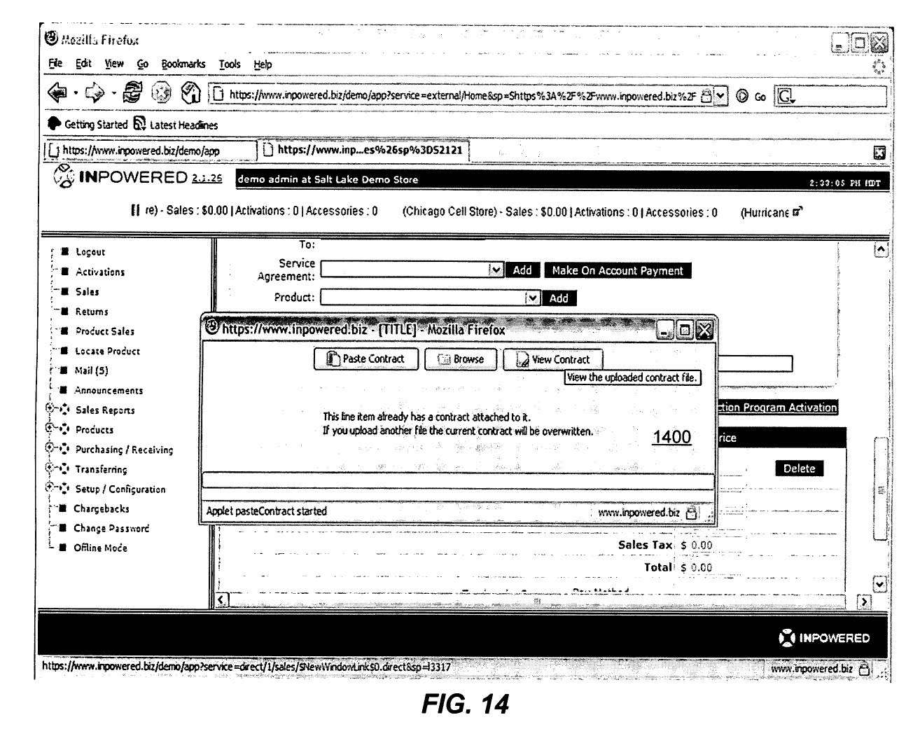

FIG. 14 is an exemplary screen capture of a dialog box 1400 for electronically storing the executed contract, according to the present invention. The rate plan contract, executed or otherwise, may be copied by the user and pasted (stored), or it may be copied automatically into the central database (304, FIGS. 3-4) for future reference or use according to embodiments of the present invention. Additionally, the executed contract may be sent electronically to the customer and/or the carrier, via email or file transfer. As shown in FIG. 14, a dialog box 1400 may facilitate pasting (storing) the contract into the central database (304, FIGS. 3-4), browsing contents of the central database (304, FIGS. 3-4) and viewing the uploaded contract file (signed or otherwise). Embodiments of the present invention are capable of storing the contracts in any suitable electronic file format, including but not limited to HTML and PDF formatted documents.

While the foregoing advantages of the present invention are manifested in the detailed description and illustrated embodiments of the invention, a variety of changes may be made to the configuration, design and construction of the invention to achieve those advantages. Hence, reference herein to specific details of the structure and function of the present invention is by way of example only and not by way of limitation.

What is claimed is:

1. A method for activating rate plans for mobile phone customers at a point-of-sale, comprising:
placing customer information into a central database;
selecting a rate plan associated with a selected carrier;
accessing an activation system for the selected carrier;
pushing customer information from the central database into the activation system;
generating a customer rate plan contract;
obtaining an executed contract; and
electronically sending the executed contract to at least one of: the customer, the carrier and the central database.

2. The method according to claim 1, wherein placing customer information comprises entering at least one of: name, address, telephone number, mobile phone number, social security number, driver license number, credit card number, billing address, business name, email address and purchase history.

3. The method according to claim 1, wherein selecting a rate plan associated with a selected carrier comprises selecting a retailer rate plan mapped to a carrier rate plan.

4. The method according to claim 1, wherein accessing an activation system for the selected carrier comprises logging into the activation system with a retailer's unique login identification and password.

5. The method according to claim 1, wherein pushing customer information into the selected carrier activation system comprises an application program interface (API) retrieving customer information from the central database and inserting it into forms on web pages in the selected carrier activation system.

6. The method according to claim 1, wherein generating a customer rate plan contract comprises copying a contract generated by the selected carrier activation system.

7. The method according to claim 1, wherein obtaining an executed contract comprises a customer signing the customer rate plan contract.

8. The method according to claim 1, wherein obtaining an executed contract comprises digitally capturing a customer signature and inserting it into the customer rate plan contract.

9. The method according to claim 1, wherein obtaining an executed contract comprises generating an Adobe Acrobat version of the customer rate plan contract with a customer signature.

10. The method according to claim 1, wherein sending the executed contract to at least one of the customer or the carrier, comprises emailing the executed contract.

11. The method according to claim 1, wherein sending the executed contract to the central database comprises copying the executed contract into the central database.

12. The method according to claim 1, further comprising pushing customer and equipment information from the central database directly into a third party warranty database.

13. The method according to claim 1, further comprising displaying current sales totals on a store-by-store basis.

14. A computer-readable medium having computer-executable instructions for performing the method according to claim 1.

15. A system for activating rate plans for mobile phone customers at point-of-sale, comprising:
a computer configured for Internet access;
a central database in communication with the computer for storing customer information; and
a web browser configured for executing computer-executable instructions for implementing a method for activating rate plans for mobile phone customers at point-of-sale, the method comprising:
placing customer information into the central database;
selecting a rate plan associated with a selected carrier;
accessing an activation system for the selected carrier;
pushing customer information from the central database into the activation system;
generating a customer rate plan contract;
obtaining an executed contract; and
sending the executed contract to at least one of: the customer, the carrier and the central database.

16. The system according to claim 15, further comprising a digital signature pad in communication with the computer for capturing customer signatures in the customer rate plan contract to obtain the executed contract.

17. The system according to claim 15, further comprising a cash drawer in communication with the computer, the cash drawer configured for storage and distribution of currency and other monetary instruments.
